(19) United States
(12) Patent Application Publication
(10) Pub. No.: US 2002/0090509 A1
(43) Pub. Date: Jul. 11, 2002

(54) Electrostatic sheets with adhesive

(75) Inventors: Chih-Chung Hsu, Woodbury, MN (US); Charles C. Lee, Little Canada, MN (US)

Correspondence Address: Attention: Dale A. Bjorkman, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/757,942

(22) Filed: Jan. 9, 2001

(51) Int. Cl. B32B 7/12; B32B 15/04; B32B 31/00

(52) U.S. Cl. 428/355 RA; 156/292

(57) ABSTRACT

Electrostatically charged graphic sheets are additionally provided with a stretch release double-sided pressure sensitive adhesive. Such sheets may be oriented on a display substrate using the electrostatically induced adhesion, and more securely fastened to the display substrate using the stretch release double-sided pressure sensitive adhesive.

### FIELD OF THE INVENTION

The present invention relates to sheets that electrostatically adhere to substrates. More specifically, the present invention relates to sheets that adhere to substrates using a combination of electrostatic charge and an additional adhesive.

### BACKGROUND OF THE INVENTION

Films have been provided with electrostatic charges, so that they will adhere to substrates without the use of adhesives. Films having persistent dielectric polarization are called electrets.

U.S. Pat. No. 5,258,214 discloses a preprinted thin plastic film wall covering having a preprinted image thereon and provided with a static electrical charge for securing the coverings to a surface.

U.S. Pat. No. 5,207,581 discloses a writing apparatus including electret film. The electret film, a flexible plastic film having a static electrical charge induced thereto, is capable of being erasably written upon with dry erase markers, as a writing medium. An apparatus is described for holding a roll of electret film.

U.S. Pat. No. 5,989,685 discloses an electret film composition adapted for printing on inkjet printers. This description provides an “improved printing material that incorporates the advantages of electreets (sic)” at column 2, lines 37-39. The advantages of electrets are stated at column 1, lines 53-55 to hold “the promise of providing a display which sticks to a surface without the use of fasteners or adhesives.” The charged sheets of this invention are attached to a paper backing to avoid problems with handling of the sheets in the paper feed mechanisms of printers. These carrier backing papers are adhered to the sheets with a glued edge. Column 4, lines 24-52.

U.S. Pat. No. 5,807,624 discloses an electrostatically charged imaging manifold. The preferred imaging manifolds “comprise a transparent, polymeric sheet imageable in an imaging sheet, and attached thereto, an opaque member underlying and in register with said transparent sheet, said opaque member being adhered to said transparent polymeric sheet by means of the combination of an electrostatic charge and a pressure-sensitive adhesive.” Column 3, lines 55-60. This adhesive is provided to provide additional protection against “scrunch,” or to improve feeding performance of the sheet with the carrier paper. See column 12, line 66- column 13, line 2.

U.S. Pat. No. 6,023,870 describes an apparatus for displaying and replacing graphic sheet on vending machines, wherein graphics sheets are removably adhered to the reverse side of the clear display panel by static cling. An alternative embodiment is disclosed at column 7, lines 38-50, which describes the use of partial adhesive or reusable adhesive, defined as a “tacky” adhesive, for the removable adhering function. The adhesive described therein is the adhesive that is used on Post-it® brand notes from 3M, and particularly illustrating the tacky adhesive as SPRAY MOUNT® artist's adhesive from 3M, commercially available consumer applicable adhesive that can be applied on location. The specification further states that the principles of the various embodiments can be combined at Column 8, lines 32-36, giving the example that a tacky adhesive may secure the comers of a product graphics sheet that has been initially positioned using the method pertaining to static cling.

### SUMMARY OF INVENTION

The present invention provides a method of removably applying an electrostatically charged graphic sheet to a display substrate. In this method, an electrostatically charged graphic sheet is provided that has a bottom surface and a top surface, with the electrostatic charge being sufficient to support said sheet on a vertical clean insulated surface. A double-sided pressure sensitive adhesive tape comprising an extensible backing is also provided, wherein the tape has a display substrate side, a graphic sheet side and a tab for manual engagement to afford manual stretching of the tape. The tape is removable from surfaces to which it is adhered by stretching. The bottom surface of the sheet is first applied to a display substrate, a portion of the applied sheet is peeled back, and the double-sided pressure sensitive adhesive tape is applied to the bottom surface of said sheet or to said display substrate. The sheet is then pressed to the display substrate, thereby removably adhering the sheet to the display substrate with the double-sided adhesive tape.

Kits for carrying out this method are also provided.

### BRIEF DESCRIPTION OF THE DRAWING

The present invention will be further described with reference to the accompanying drawings, in which:

FIG. 1 is a cross-sectional side view of a stretch release adhesive article used in the present invention including continuous release liners extending along the entire length of each side of the article;

FIG. 2 is a cross-sectional side view of a stretch release adhesive article adhered to a graphic sheet and a display substrate;

FIG. 3 is a cross-sectional side view of a stretch release adhesive article during the stretch removal process.

### DETAILED DESCRIPTION OF THE PRESENTLY PREFERRED EMBODIMENTS

As noted above, electrostatically charged sheets for application to various surfaces are known. The major advantage cited for these systems is the ability to adhere a sheet to an intended ultimate substrate without the use of adhesive. Thus, it was the primary objective in the prior art to avoid using an adhesive.

It has been found that over time that the charge in an electrostatically charged sheet will at least partially dissipate, and the adhesion of the sheet to the intended substrate will fail. This is particularly the case where sheets have been subjected to certain printing processes, such as offset printing. See U.S. Pat. No. 5,904,985 at column 2, lines 5-18. To provide adequate charge to hold the sheets at the desired location, the sheets have previously been recharged.

The present invention provides a combination adhesion system that provides adhesion both through electrostatic charge and also through a pressure sensitive adhesive. In the present invention, a positionable sheet is provided whereby the location of the sheet can be determined through the easily movable adhesion of the sheet to the display substrate, followed by more securely adhering the sheet to the substrate by the pressure sensitive adhesive. Prior uses of electrostatically charged sheet materials provided a graphic sheet that was subject to repositioning or even removal by accident. Thus, the accidental brush by a passerby or a gust of wind, such as from a fan, could move or remove the graphic sheet. The present invention provides secure adhesion for a graphics sheet that is attached to a display substrate using electrostatic charge.

In another aspect of the present invention, a more complete adhesion of the sheet to a display substrate is accomplished through the co-action of the electrostatic charge adhesion and the pressure sensitive adhesive adhesion. Thus, the entire sheet can be in intimate adhesive contact with the display substrate, even though pressure sensitive adhesive is located only at a few points. This provides the advantage of not having “tenting,” or physical separation of the sheet from the display substrate, at portions of the sheet that does not have pressure sensitive adhesive located thereon. Because there is co-action of both the electrostatic charge and the stretch release pressure sensitive adhesive, the electrostatic charge does not have to be so strong as to support the entire weight of the graphic sheet over the entire life of the product. Likewise, the adhesive strength of the stretch release pressure sensitive adhesive need not be so strong as to support the entire weight of the graphic sheet over the entire life of the product, because it will be assisted by the adhesive effect of the electrostatic charge.

Additionally, the present invention makes it possible to achieve complete adhesion of the sheet to the display substrate without requiring a continuous coating of adhesive on the sheet. Sheets having a continuous coating of adhesive may be difficult to apply to a display substrate without creating wrinkles or capturing air bubbles. Thus, the present invention provides a graphic sheet that is easy for the non-skilled person to apply to a display substrate and subsequently adjust to provide perfect positioning and appearance before commitment to that location by adhesion.

The use of the stretch release adhesive tape allows for an adhesive system to be used that will adhere to any surface, yet be cleanly removable without causing damage to that surface. Thus even very aggressive adhesives can be used in the stretch release tape such that the graphic sheet can be made to adhere to difficult rough surfaces, such as painted brick, without falling off of the display substrate. Even with the aggressive adhesive, the product can be safely removed without damage to the display substrate (e.g. removing the paint on a painted surface) due to the stretch release configuration of the pressure sensitive adhesive.

For purposes of the present invention, a “display substrate” is a substrate that is the desired ultimate location for placement of the sheet of the present invention for use in its final function as a graphic article, e.g. as a wallcovering or media surface. A display substrate is distinguished from a carrier substrate, in that a carrier is merely a vehicle for transporting a fragile film to another destination. Prior art films have used an adhesive for adhering a film to a carrier substrate, but this adhesive was then presumably destroyed or removed upon removal of the carrier substrate and before application of the electrostatic film to the display substrate. The prior art emphasizes the value of providing a sheet that adheres to the ultimate surface without resort to an adhesive. While the application of the sheet of the present invention to any particular display substrate may be temporary and subsequent applications of this sheet to another display substrate may be contemplated, the display substrate is not merely a carrier, and does not destroy the function of the adhesive before use of the sheet for its desired function.

For purposes of the present invention, a sheet is “securely” adhered to a substrate if, upon application of slight finger or hand pressure in a sliding action in a direction parallel to the surface of the display substrate, the sheet does not slide.

In a preferred embodiment of the present invention, the graphic sheet is imageable. In one preferred embodiment, the top surface of the film is imageable. In another preferred embodiment, the top surface of the film is coated to provide an imageable surface. In yet another preferred embodiment, the sheet is a laminate comprising an image receptive layer on the top surface of the film.

In an alternative embodiment of the present invention, the sheet is a preimaged wallcovering. The present invention provides a significant benefit in this embodiment, in that an effective replacement for traditional wallpaper may now be provided. With the combination of adhesion through electrostatic charge and pressure sensitive adhesive, wall covering may now be applied without the use of messy adhesives and pastes as conventionally used. Additionally, the present invention provides a dimensionally stable wallcovering, because there is no need to expose the backing to water or other liquid during the application process that would expand the wallcovering when wet and shrink the wallcovering as it dries. The wallcovering may be applied to the wall with an infinite working time to position the covering to allow matching of patterns and the like, with final adhesion only created when the applier is certain of proper placement. Thus, the preferred pressure sensitive adhesive is one that provides maximum positionability of the sheet prior to final adhesion. Additionally, the pressure sensitive adhesive preferably creates a strong bond to the display substrate, so that the expected bonding lifetime of this preferred embodiment is at least 5 years or more.

Preferred embodiments of wallcovering according to the present invention are provided in a roll form that is at least 20 feet (6.1 meters) in one dimension. Particularly preferred embodiments of wallcovering have a pattern printed thereon having a matching design on one edge that, when mated to the corresponding pattern on the opposite edge of an adjacent sheet, provide an aesthetic overall design to the surface of the display substrate.

In another embodiment of the present invention, the graphic sheet is a writing surface capable of being written upon after application to a display substrate. Preferably, the graphic sheet is capable of being erasably written upon, for example, with dry erase markers. In this embodiment, the sheet is an easily placeable writing surface that is a replacement or adjunct to the traditional blackboard writing surface.

The adhesive of the present invention is a double-sided pressure sensitive adhesive (“DSPSA”) is a removable adhesive wherein pressure sensitive adhesive is provided on both sides of an extensible backing. Such adhesive articles may be generically referred to as a stretch release adhesive tape. These tapes operate in that when the backing is stretched after the tape is adhered on one side or both sides, the adhesive stretches and undergoes clean interfacial debonding from the substrate or substrates to which it is adhered. Such removal typically progresses from one end of the tape to the other as the tape backing is stretched at an angle preferably no greater than about 35° from the surface of the substrate. That is, as the tape is stretched from one end, it debonds from the end being stretched toward its distal end.

Particularly preferred embodiments of the present invention use adhesive tapes that have plastic backings. That means, as the backing is stretched, it is permanently deformed and has relatively low elastic recovery. Such tapes include tapes comprising film layers, foam layers, and laminates of films and/or foams.

Co-pending U.S. patent application Ser. No. 08/308,937 (WO 95/06691), which is commonly owned by the Assignee of the present invention, discloses a number of stretchable release tapes comprising constructions of films, foams, and laminates of films and/or foams. Again, such tapes include conventional pressure-sensitive adhesives.

Another type of stretchable release adhesive tape is described in U.S. Pat. No. 5,409,189 to Lüihmann, wherein the adhesive tape backings utilized comprise elastic materials. Elastic, as opposed to plastic materials described above, means materials that are stretchable without substantial plastic deformation and which have high elastic recovery after stretching and release. Like the plastic tapes described above, elastic tapes can be single-sided or double-sided and the stretching of the backing causes adhesive stretching and subsequent debonding of the adhesive surface or surfaces from the stretched end to the distal end as the tape is stretched.

Preferred embodiments of stretchable release tapes that may be used in the present invention are described in U.S. Pat. No. 6,001,471. Other preferred embodiments are described in U.S. Pat. Nos. 5,672,402; 5,516,581; 4,024,312; 6,162,534; and German Patent Document 33 31 016 C2. In addition, the stretch releasing tape can include a splittable layer such as the layers described in U.S. Pat. No. 6,004,642, or a re-fastenable layer such as the layers described in PCT International Publication No. WO 99/31193 (U.S. patent application Ser. No. 08/989,507, filed Dec. 12, 1997.

Commercial stretch releasing adhesive tapes include the product sold under the trade designation COMMAND by Minnesota Mining and Manufacturing Company, St. Paul, Minn., and the product sold under the trade designation POWER-STRIPS by Beiersdorf AG, Hamburg, Germany. These products are currently manufactured as discrete strips with one end of the strip including a non-adhesive pull tab to facilitate stretching of the strip during removal. The adhesive surfaces of the strip are additionally protected with a release liner.

Optionally, the side of the DSPSA that is to be applied to the graphic sheet may be selected from any pressure sensitive adhesive. Preferably, the side of the DSPSA that is to be applied to the graphic sheet is also easily removed from the graphic sheet without damage to said sheet. By “removable” is meant that the adhesive can be removed from the substrate without damage to that substrate. Preferably, the adhesive can be removed from a sheet of U.S. Gypsum ⅜″ (9.5 mm) sheetrock that was painted first with Sherwin Williams ProMar™ 200 interior latex primer, then with a single top coat of Sherwin Williams Classic™ 99 interior flat latex wall paint. The painted wallboard was aged under ambient conditions at about 22° C. for a minimum of 48 hours prior to use for testing. More preferably, said adhesive can be removed from 20 pound white bond xerographic quality paper without tearing the paper.

In a preferred embodiment of the present invention, the display substrate side of the DSPSA is a repositionable pressure sensitive adhesive. As used herein, “repositionable” refers to the ability to be repeatedly adhered to and removed from a substrate without substantial loss of adhesion capability. Preferably, the display substrate side of the DSPSA of the present invention may be adhered to and removed from a 20 pound white bond xerographic quality paper for 5 cycles using a 2 kg roller weight with no more than 75% loss of peel adhesion. Most preferably, both sides of the DSPSA exhibit these properties. In another aspect, the present invention is preferably removable from a display substrate when it has been adhered to the display substrate over a long period of time. Thus, preferably the adhesive used in the present invention does not develop excessive adhesion build-up over time.

Preferably, the repositionable pressure sensitive adhesive provided in the DSPSA comprises between about 60-100% by weight of hollow, polymeric, acrylate, inherently tacky, infusible, solvent-insoluble, solvent-dispersible, elastomeric pressure-sensitive adhesive microspheres having a diameter of at least 1 micrometer, and between about 0-40% by weight of a non-spherical polyacrylate adhesive. These hollow microspheres are made in accordance with the teaching of European Patent Application 371,635. The non-spherical polyacrylate adhesive may be any conventional pressure-sensitive adhesive. Examples of such adhesives are polymers made from the “soft” monomers such as n-butyl acrylate, isooctyl acrylate, or the like, or copolymers made from a soft component, such as isobutylene, n-butyl acrylate, isooctyl acrylate, ethyl hexyl acrylate, or the like; and a polar monomer such as acrylic acid, acrylonitrile, acrylamide, methacrylic acid, methyl methacrylate or the like. Non-spherical polyacrylate adhesives are commercially available, for example, as the Rohm and Haas Rhoplex™ line of adhesives. Preferably, the non-spherical polyacrylate adhesive is present in the repositionable adhesive at an amount of about 10-35% by weight. When the repositionable adhesive additionally comprises a non-spherical polyacrylate adhesive, improved anchorage of the total adhesive to the sheet is observed, resulting in less adhesive residue being left on the substrate after removal. Also, tacky microsphere-containing repositionable adhesives comprising non-spherical polyacrylate adhesive exhibit excellent shear adhesion properties, even for highly textured vertical surfaces. These advantageous adhesive properties are obtained without excessive adhesion to substrates such as painted walls that would result in peeling of the paint off of the wall when the film adhesive composite is removed.

Repositionable adhesives are also known in which microspheres contained in the adhesive are non-tacky. A disclosure of this type of adhesive is provided in U.S. Pat. No. 4,735,837 to Miyasaka.

A repositionable adhesive may be provided by addition of components to conventional adhesive formulations to modify their tack and flow characteristics. U.S. Pat. No. 4,599,265 (Esmay) discloses an adhesive having a high degree of cohesive strength that has low tack and maintains peelability from a variety of ordinary substrates. U.S. Pat. No. 4,737,559 (Kellen et al.) describes a PSA formulation in which the viscous flow, and resultant adhesion buildup, is controlled through the addition of a small amount of a free radically polymerizable photocrosslinker.

Another means for providing a repositionable adhesive through the reduction of the adhesive contact area is accomplished by the deposition of a discontinuous or patterned film on a backing. WO 85/04602 (Newing et al.) describes pressure-sensitive adhesive articles comprising a plurality of discontinuous adhesive segments in a pattern on at least a portion of at least one side of a carrier or backing, covering from about ten to about thirty percent of the total surface area of that carrier material. European Patent Application 276,557 (Fry) describes a repositionable pressure-sensitive sheet material comprising a sheet material bearing on one surface a discontinuous non-repetitive adhesive coating covering about 10 to about 85 percent of the surface in the form of individual adhesive islands. U.S. Pat. No. 4,889,234 (Sorenson et al.) discloses a discontinuous patterned adhesive label structure in which the level of adhesion is varied according to area of adhesive coverage on the label, the pattern in which the adhesive is coated, and the full coverage adhesive characteristics of the materials used. European Patent Application 279,579 (Tanuma et al.) describes pressure-sensitive adhesive sheets comprising, in one embodiment, a continuous adhesive layer having “irregular sections” (i.e., “ . . . the pressure-sensitive adhesive layer is uneven . . . ”). The uneven adhesive layer, according to the application, is imparted through a variety of pressing, molding, and embossing methods.

The electrostatically charged film used in the present invention is preferably prepared by passing the film through an electrostatic field. This field can be generated by any known electric charge generator, e.g., a corona charger, a tribocharger, conducting high potential roll charge generator or contact charger, a static charge generator, and the like. Samples may be charged with a DC charge or a DC charge followed by an AC charge in order to create an adequate level of charge adhesion between the two surfaces. Preferably, the film is passed through the electrostatic field while in a molten or semi-molten state, and is cooled down before the charge dissipates, thereby “locking in” the charge and providing an electret having long-lasting electrostatic properties. The film is sufficiently charged so as to be able to support the graphic sheet on a vertical clean insulated surface. The ability of a graphic sheet to so support itself is evaluated by application to a sheet of U.S. Gypsum ⅜″ (9.5 mm) sheetrock that was painted first with Sherwin Williams ProMar™ 200 interior latex primer, then with a single top coat of Sherwin Williams Classic™ 99 interior flat latex wall paint. The painted wallboard was aged under ambient conditions at about 22° C. for a minimum of 48 hours prior to use for testing. A graphic sheet is considered to be able to support itself if, upon placement on a vertical surface as described above without activation of the activatable adhesive at a temperature of about 22° C., the sheet does not fall off for at least five minutes.

Preferably, the film comprises a polymer selected from the group consisting of polypropylene, polyethylene, polyester, polyamide, polyimide, polyurethane, polyethylene acrylic acid, polyvinyl chloride, polyethylene methacrylic acid, thermoplastic rubbers, polypropylene oxides, polystyrenes, polystyrene-polydiene block copolymers, ionic thermoplastic elastomers, polyethers, polyesteramides, polyetheresteramides, siloxanes, ethylene vinyl acetate, polymethyl methacrylate (PMMA), polyvinyl dichloride (PVDC), acetate copolymers, polybutenes, fluorine-containing elastomers, silicone rubbers, polycaprolactones, and elastomeric block copolymers, and blends and combinations thereof.

In a particularly preferred embodiment, the graphic sheet of the present invention is imageable. In one embodiment, the electrostatically charged film is selected from a film chemistry that is receptive to receive and retain the printing of an image thereon. Alternatively, the electrostatically charged film is treated physically or chemically using techniques well known in the art to enhance the image reception and retention of the film chemistry. In another embodiment, the graphic sheet is provided as a laminate, with an image receptive layer laminated to the film. Lamination may be by any appropriate technique in the art, such as by adhesion or coextrusion. The film may be electrostatically charged either before or after treatment or lamination to provide the image receptive graphic sheet.

Preferably, the imageable graphic sheet is receptive to one or more of a wide variety of imaging methods, such as electrography, screen printing, thermal mass transfer, ink jet (including ink jet techniques using water soluble inks, solvent based inks or UV curable inks), flexography, dye sublimation, or other printing processes.

In addition to the optional layers mentioned above, a multilayer sheet in accordance with the present invention can include other optional layers, such as an abrasion and/or graffiti resistant layer and the like.

Optionally, the bottom surface of the graphic sheet may be provided with a surface topography such that fluid (including air) is allowed to escape as the bottom surface of the graphic sheet is applied to the display substrate. Preferably, the topography of the bottom surface is such that a person of ordinary vision cannot detect the presence of entrapped air bubbles at a distance of two meters from the graphic sheet after application to a display substrate. Preferably, this topography is provided in the form of microchannels or grooves provided in a pattern effective to reduce or eliminate formation of visible entrapped air bubbles between the graphic sheet and the display substrate. The preferred microchannels may have any appropriate cross-sectional shape, such as round, square, triangular or trapezoidal. Size of the microchannels may depend on the thickness of the graphic sheet, and preferably may be in the range of less than 0.1 mm wide and less than 25 mm deep. Preferably, the microchannels are arrayed such that the electrostatic cling performance of the graphic sheet is not adversely affected. Most preferably, the bottom surface of the graphic sheet has a contact area to the display substrate of at least 35%. Additionally, the topography of the bottom surface of the graphic sheet is preferably designed such its presence does not adversely effect the appearance of the graphic after application to the display substrate. Most preferably, the topography of the bottom surface is such that a person of ordinary vision cannot detect its presence at a distance of two meters from the graphic sheet after application to a display substrate. Examples of such topography are described in U.S. patent application Ser. No. 09/098,961, filed Jun. 18, 1998 (WO 99/65999).

Any of the layers above, whether optional or not, may include at least one optional additive. An optional additive can be selected from additional pigments, colorants, fillers, ultraviolet (UV) absorbing agents, antiblocking agents, flame retardant agents, plasticizers, light stabilizers, heat stabilizers, slip agents, antistatic agents, free radical scavangers, and carrier resins for such additives, all of which are familiar to those skilled in the art. These additives are preferably chosen so as not to interfere with a coextrusion processes, image receptivity, structural integrity any layer or the combination of any multilayer embodiment, and the like.

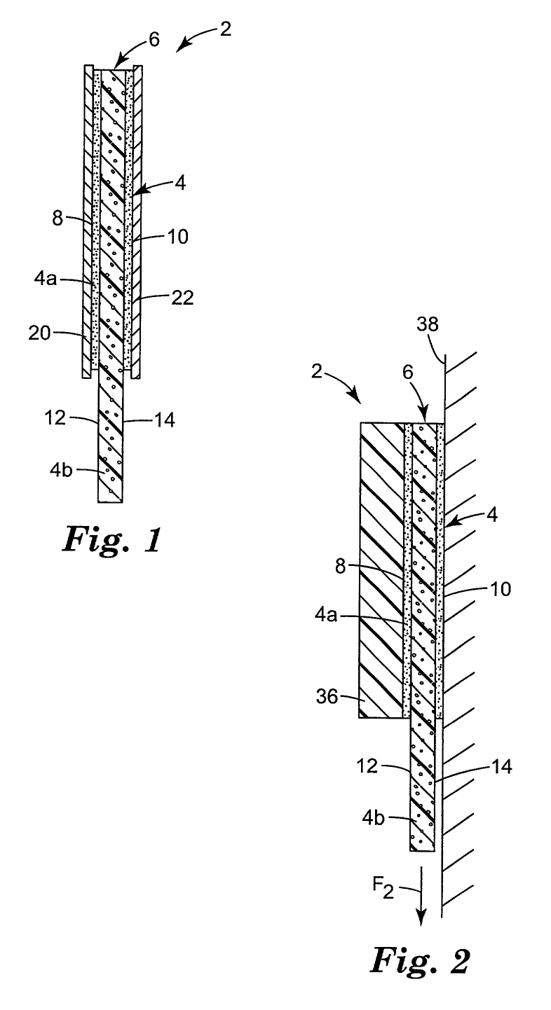

Referring now to the Figures, wherein like reference numerals are used to designate like features throughout, and first to FIG. 1, there is shown a stretch releasing adhesive article 2 including a stretch releasing adhesive strip 4 and a secondary release member 6.

The stretch release adhesive strip 4 includes an adhesive first end portion 4a having adhesive oppositely facing first and second major surfaces 8, 10, and a tab portion 4b having non-adhesive oppositely facing first and second major surfaces 12,14. Suitable stretch releasing adhesive strips are described in, for example, U.S. Pat. No. 5,516,581 to Kreckel et al., U.S. Pat. No. 5,507,464 to Hamerski et al., U.S. Pat. No. 5,409,189 to Lühmann, and DE-OS 33 31 016.

Prior to use, protective release liners 20, 22 are provided over the adhesive surfaces 8 10, respectively, The release liners 20, 22 can be, for example, a silicone release paper, non-adhesive polyester films, non-adhesive foams, or any conventional material which has been appropriately coated or treated with a suitable non-adhesive material so as to render it non-adhesive. Suitable non-adhesive coating materials include conventional powders and inks. As shown in FIG. 1, a single continuous release liner 20, 22 can extend along the entire length of each side of the adhesive article 2, thereby covering the stretch release adhesive strip adhesive surface 8, 10.

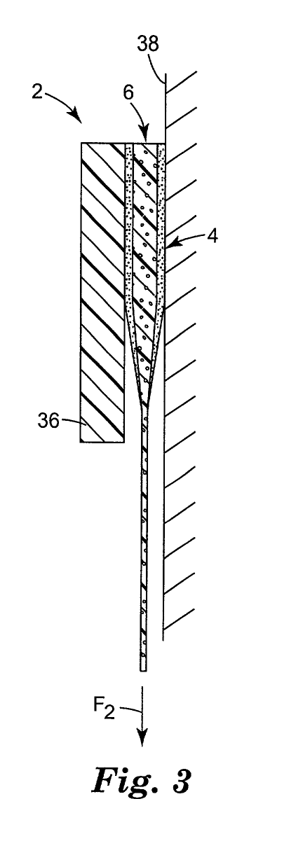

Application and removal of an adhesive article to a graphic sheet 36 and display substrate 38 is shown in FIGS. 2 and 3. To adhesively bond a graphic sheet 36 to a display substrate 38, the release liners covering the adhesive surfaces are removed to expose the underlying adhesive.

Removal is accomplished by applying a force F2 to the tab portion 4b of the stretch release adhesive strip 4. The force F2 causes the stretch release adhesive strip 4 to stretch and progressively debond from the graphic sheet 36 and display substrate 38 as shown in FIG.3.

The disclosures of patents and patent applications cited herein are hereby incorporated by reference.

What is claimed is:

1. A method of removably applying an electrostatically charged graphic sheet to a display substrate, comprising
a) providing an electrostatically charged graphic sheet having a bottom surface and a top surface, said electrostatic charge being sufficient to support said sheet on a vertical clean insulated surface,
b) providing a double-sided pressure sensitive adhesive tape comprising an extensible backing, said tape having a display substrate side, a graphic sheet side and a tab for manual engagement to afford manual stretching of the tape, said tape being removable from surfaces to which it is adhered by stretching said tape,
c) applying the bottom surface of said sheet to a display substrate,
d) peeling back a portion of said applied sheet and applying said double-sided pressure sensitive adhesive tape to the bottom surface of said sheet or to said display substrate,
e) pressing said sheet to said display substrate, thereby removably adhering said sheet to said display substrate with said double-sided adhesive tape.

2. The method of claim 1, wherein the display substrate side of said double-sided pressure sensitive adhesive is repositionable.

3. The method of claim 1, wherein both sides of said double-sided pressure sensitive adhesive are repositionable.

4. The method of claim 1, wherein the double-sided pressure sensitive adhesive having pressure sensitive adhesive provided on both sides thereof.

5. The method of claim 1, wherein the graphic sheet is a preimaged wallcovering.

6. The method of claim 5 wherein said wallcovering is provided in a roll form that is at least 20 feet in one dimension.

7. The method of claim 1, wherein the graphic sheet is a writing surface capable of being written upon after placement on a display substrate.

8. The method of claim 1, wherein the graphic sheet is a writing surface capable of being eraseably written upon with dry erase markers after placement on a display substrate.

9. The method of claim 1, wherein the bottom surface of the graphic sheet is provided with a surface topography such that fluid is allowed to escape as the bottom surface of the graphic sheet is applied to the display substrate.

10. A kit for removably applying an electrostatically charged sheet to a display substrate, comprising
a) a graphic sheet comprising a film having a top and bottom surface, said film having an electrostatic charge sufficient to support said sheet on a vertical clean insulated surface, and
b) a double-sided pressure sensitive adhesive tape comprising an extensible backing, said tape having a display substrate side, a graphic sheet side and a tab for manual engagement to afford manual stretching of the tape, said tape being removable from surfaces to which it is adhered by stretching said tape
c) instructions for applying said graphic sheet to a display substrate utilizing the electrostatic charge and the double-sided pressure sensitive adhesive tape.

11. The kit of claim 10, wherein the display substrate side of said double-sided pressure sensitive adhesive is repositionable.

12. The kit of claim 10, wherein both sides of said double-sided pressure sensitive adhesive are repositionable.

13. The kit of claim 10, wherein the graphic sheet is a preimaged wallcovering.

14. The kit of claim 13 wherein said wallcovering is provided in a roll form that is at least 20 feet in one dimension.

15. The kit of claim 10, wherein the graphic sheet is a writing surface capable of being written upon after placement on a display substrate.

16. The kit of claim 10, wherein the graphic sheet is a writing surface capable of being eraseably written upon with dry erase markers after placement on a display substrate.
